(19) United States
(12) Patent Application Publication
(10) Pub. No.: US 2008/0194297 A1
(43) Pub. Date: Aug. 14, 2008

(54) Sir Determining Apparatus and Wireless Communication Apparatus

(75) Inventor: Yasuyuki Nose, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/915,025

(22) PCT Filed: Jul. 27, 2005
(86) PCT No.: PCT/JP2005/013721

§ 371 Date: Nov. 20, 2007

(51) Int. Cl. H04B 1/38

(52) U.S. Cl. 455/561

(57) ABSTRACT

It is an object of the present invention to realize a SIR detection device and a radio communication device capable of detecting the value of a ratio of a signal component to an interference component (SIR: Signal to Interference Ratio) indicating the power ratio of a signal component to an interference component of a radio signal with precision. To attain this object, the SIR is detected, a value of power N added to the radio signal by internal noise of a radio processing section (4) is determined based on a NF (Noise Figure) of the radio processing section that performs analog signal processing in a RF (Radio Frequency) area of the radio signal, a value of power I of an interference component included in the radio signal is determined based on a RSSI (Received Signal Strength Indicator) indicating reception strength of the radio signal, and calculation is performed on the detected SIR value with the amount of correction based on the power N of the internal noise and the power I of the interference component, thereby making a correction of removing the power N of the internal noise included in the SIR.

### TECHNICAL FIELD

The present invention relates to radio communication devices installed in radio base stations which carry out a relay operation and the like of communications via mobile telephones, transceivers and the like, and more particularly to a SIR detection device and a radio communication device capable of accurately detecting a ratio of a signal component to an interference component (SIR: Signal to Interference Ratio) in radio communications.

### BACKGROUND ART

A radio communication device installed in a radio base station typically includes an antenna serving as a gate for transmitting and receiving a radio signal, a transmitting and receiving device which performs analog signal processing in a RF (Radio Frequency) area of the radio signal in the subsequent stage to the antenna, and a baseband processing section which performs signal processing (digital or analog signal processing) in a baseband area of the radio signal in the subsequent stage to the transmitting and receiving device.

The transmitting and receiving device which performs analog signal processing in the RF area is provided with a radio processing section including a variable gain amplifier, an attenuator and the like. The structure of such radio processing section is discussed at length in patent documents 1 and 2 indicated below.

This radio processing section is composed of various kinds of electric elements including a transistor. Because electric elements typically generate noise, the SN ratio (Signal to Noise Ratio) of a radio signal passing through the radio processing section deteriorates to some degree. One of the parameters indicative of the deterioration of the SN ratio is a NF (Noise Figure), which indicates how many times the input thermal noise is generated equivalently as internal noise by the radio processing section.

The CDMA (Code Division Multiple Access) system is one of the systems for mobile communications. In the CDMA system, user signals are identified using codes allocated individually to users. Thus, when the codes do not affect one another at all, a signal for each user can be restored to its original signal without being affected at all by the other signals. In an actual transmission path, however, a component exists which affects one another among the respective codes due to various factors, and the amount of this effect restricts the number of users that can be accommodated in the system. Such component which affects one another among the codes in a transmission path is called an interference component.

In the baseband processing section in the radio communication device, a SIR detection devices detects a ratio of a signal component to an interference component (SIR: Signal to Interference Ratio) indicating the power ratio of a signal component to an interference component of the radio signal. In detecting this SIR, information about RSSI (Received Signal Strength Indicator) is used which indicates the reception strength of a radio signal generated by the transmitting and receiving device in order to determine a value of the interference component. Yet the value of this RSSI includes not only the interference component but also the effect of the NF possessed by the radio processing section. This prevents a SIR value from being detected with precision.

Also in the CDMA system, a SIR is estimated by demodulating pilot bits. But the estimated SIR value includes an error depending on the number of pilot bits demodulated. This prevents a SIR value from being detected with precision.

Patent document 1: Japanese Patent Application Laid-Open No. 2000-183762

Patent document 2: Japanese Patent Application Laid-Open No. 2000-216652

### DISCLOSURE OF THE INVENTION

### Means to Solve the Problems

It is an object of the present invention to solve such problems as mentioned above, and realize a SIR detection device and a radio communication device capable of detecting a SIR value with precision.

A SIR detection device and a radio communication device according to the present invention detects a ratio of a signal component to an interference component (SIR: Signal to Interference Ratio) indicating the power ratio of a signal component to an interference component of a radio signal; determines a value of power N added to the radio signal by internal noise of a radio processing section (4) based on a NF (Noise Figure) of the radio processing section that performs analog signal processing in a RF (Radio Frequency) area of the radio signal; determines a value of power I of an interference component included in the radio signal based on a RSSI (Received Signal Strength Indicator) indicating reception strength of the radio signal; and performs calculation on the detected value of the SIR with the amount of first correction based on the power N of the internal noise and the power I of the interference component, thereby making a first correction of removing the power N of the internal noise included in the SIR.

### EFFECTS OF THE INVENTION

According to the present invention, the calculation is performed on the detected value of the SIR with the amount of first correction based on the power N of the internal noise added to the radio signal by the radio processing section and the power I of the interference component, thereby making the first correction of removing the power N of the internal noise included in the SIR. As a result, a SIR not affected by the internal noise of the radio processing section is obtained, thereby realizing a SIR detection device and a radio communication device capable of detecting a SIR value with precision.

These and other objects, features, aspects and advantages of the present invention will become more apparent from the following detailed description of the present invention when taken in conjunction with the accompanying drawings.

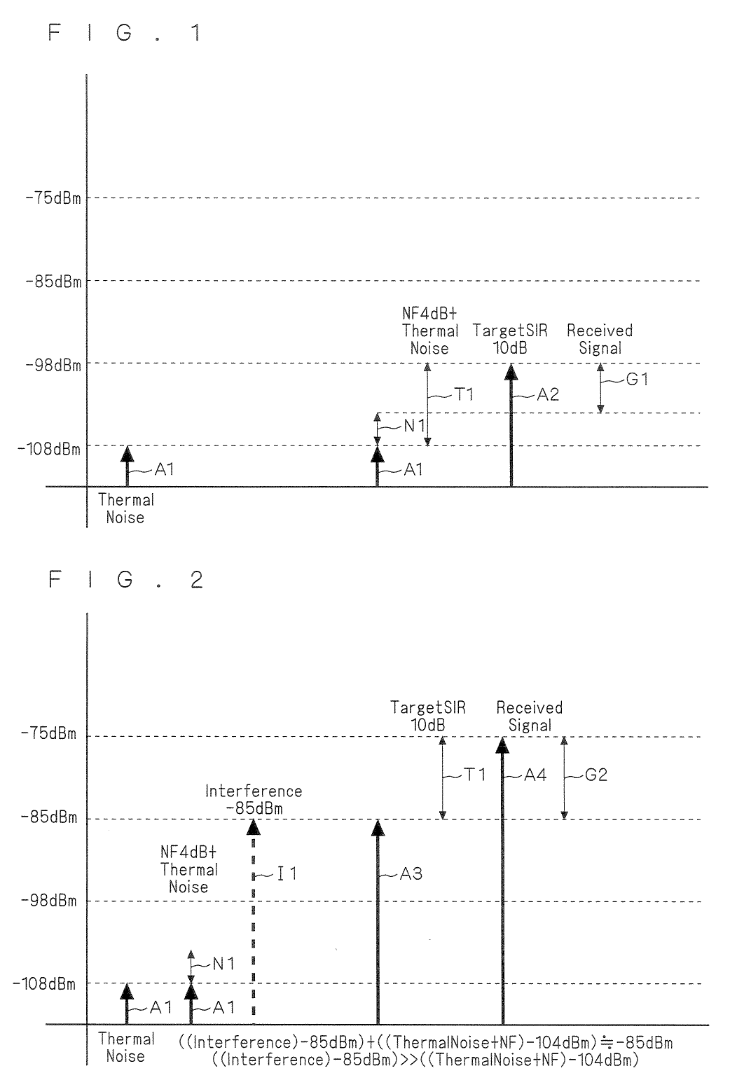

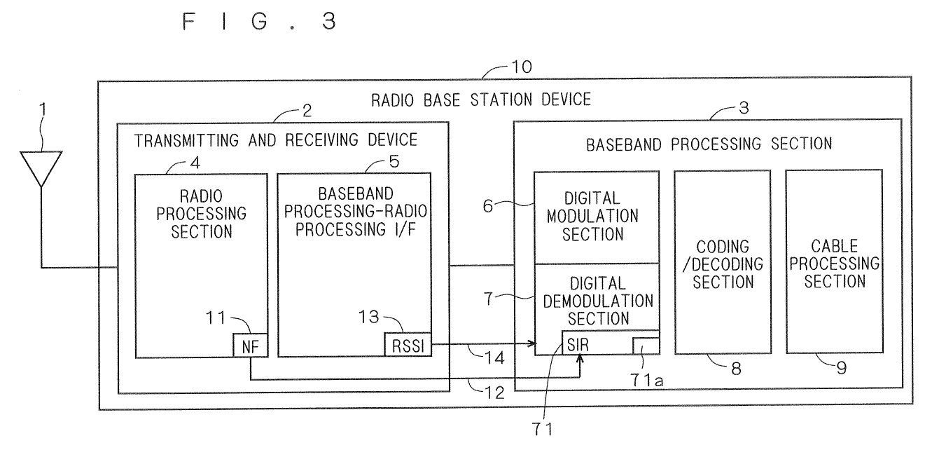

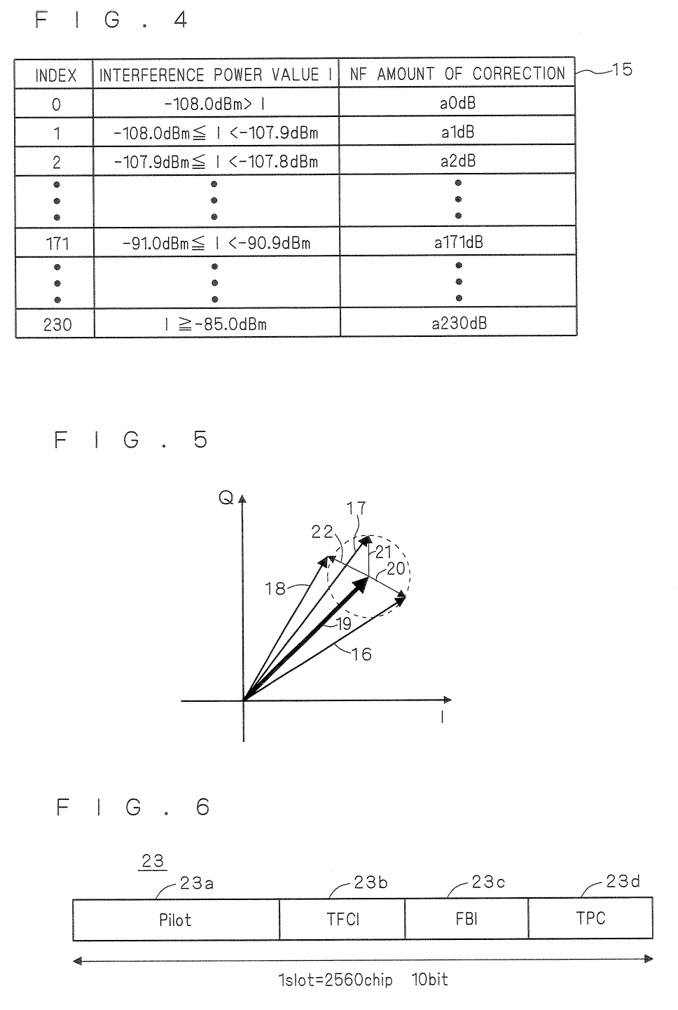

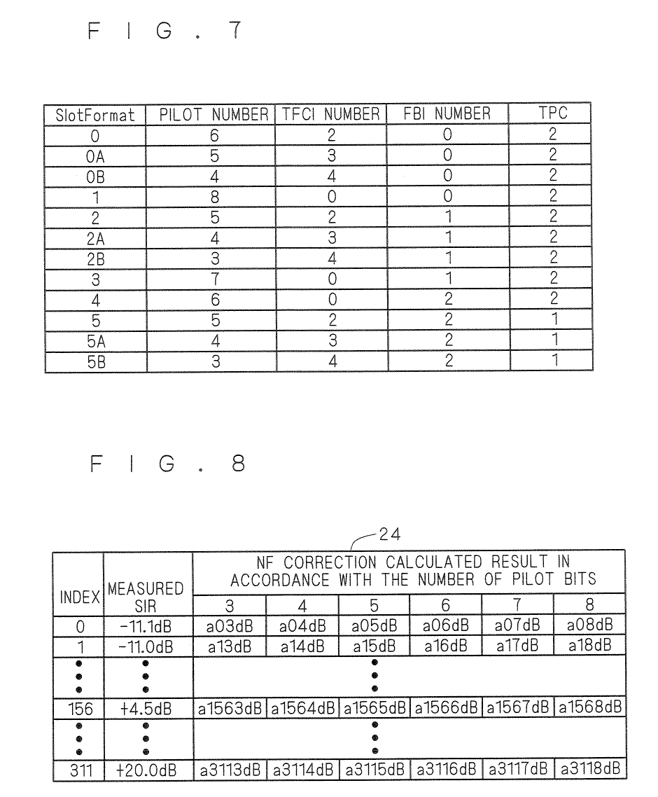

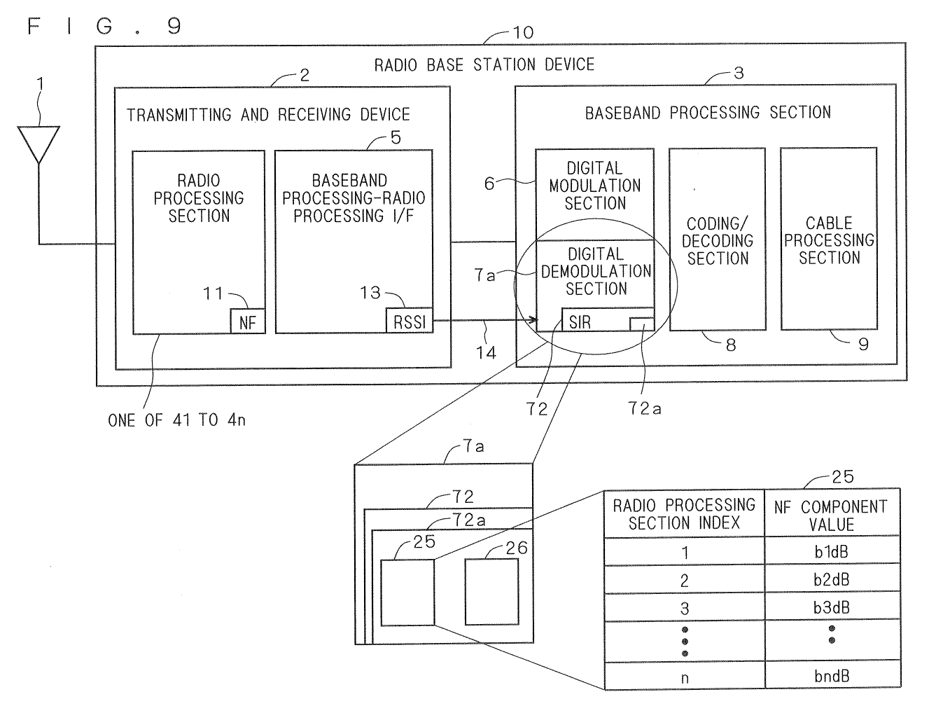

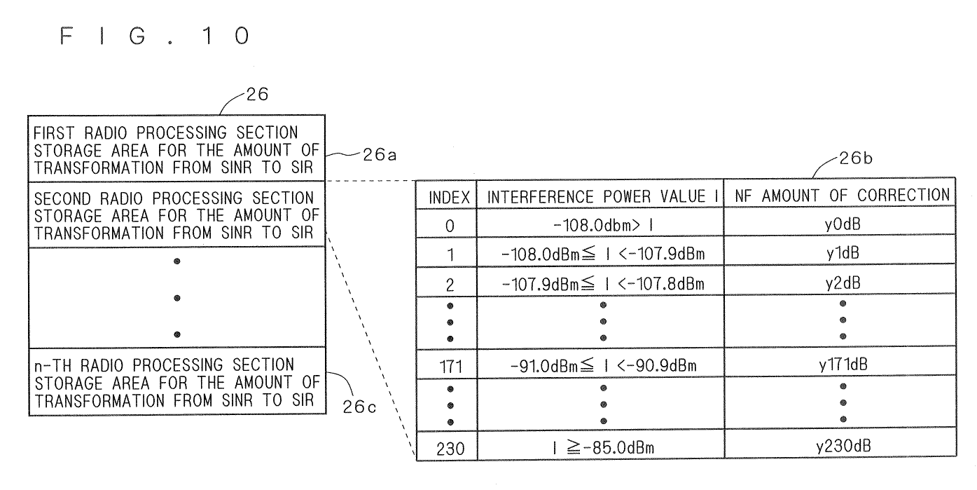

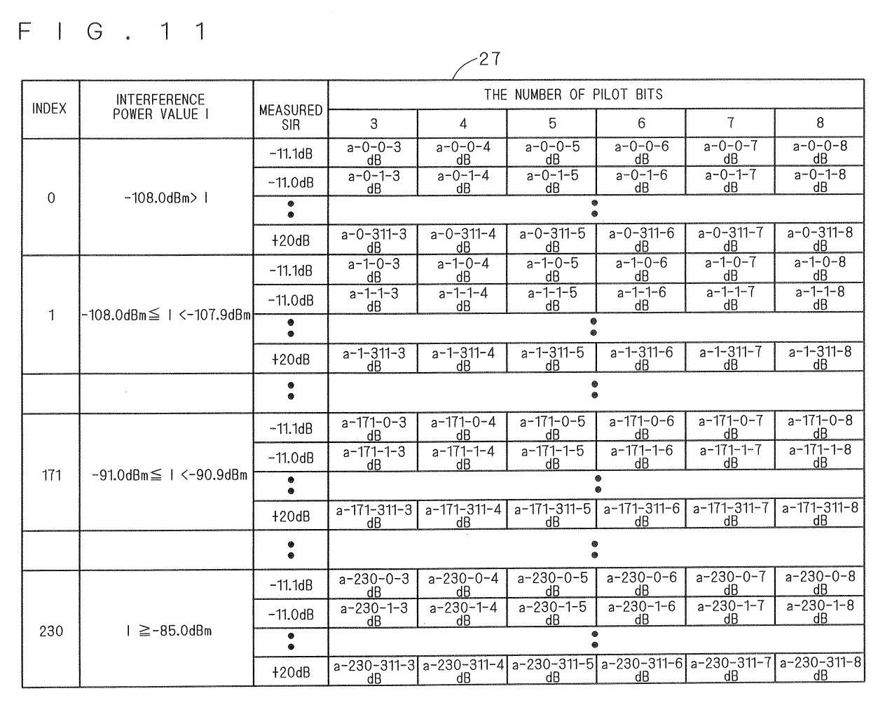

### BRIEF DESCRIPTION OF THE DRAWINGS

[FIG. 1] explains the effect which internal noise (thermal noise) generated by a radio processing section has on SIR detection.

[FIG. 2] illustrates another example for explaining the effect which internal noise (thermal noise) generated by a radio processing section has on SIR detection.

[FIG. 3] shows the structure of a radio base station device serving as a radio communication device according to a first preferred embodiment.

[FIG. 4] shows a table of the amounts of correction in a SIR detection device.

[FIG. 5] shows vectors obtained by calculating back diffusion of a pilot bit signal in the CDMA system.

[FIG. 6] shows the structure of an upward control signal of the W-CDMA.

[FIG. 7] shows a table indicating various indexes in the Slot Format and the numbers of those indexes.

[FIG. 8] shows a table which stores calculated results using the amounts of correction in the SIR detection device.

[FIG. 9] shows the structure of a radio base station device serving as a radio communication device according to a third preferred embodiment.

[FIG. 10] shows a table which stores each of the calculated amounts of correction for each of a plurality of radio processing sections and for each of the ranges of possible values for power I of an interference component in the SIR detection device.

[FIG. 11] shows a table for collectively making first and second corrections.

### EXPLANATION OF THE REFERENCED NUMERALS

1 antenna, 2 transmitting and receiving device, 3 baseband processing section, 4, 41 to 4n radio processing section, 5 baseband processing-radio processing interface, 6 digital modulation section, 7, 7a digital demodulation section, 71, 71 SIR detection device, 8 channel coding/decoding section, 9 cable processing section, 10 radio base station device, 11 NF detection section, 12, 14 interface, 13 RSSI measurement section.

### BEST MODES FOR CARRYING OUT THE INVENTION

### First Preferred Embodiment

This embodiment is directed to a SIR detection device and a radio communication device which performs calculation on a detected SIR value with the amount of correction based on power N of internal noise added to a radio signal by a radio processing section and power I of an interference component, thereby making a correction of removing the power N of the internal noise included in the SIR.

First, with reference to FIG. 1, a description is given of the effect which internal noise (thermal noise) generated by the radio processing section has on SIR detection. FIG. 1 illustrates an ideal state where an interference component which exists in a transmission path has a very small value as a component that affects a radio signal, and only a spectrum A1 of thermal noise on the transmission path is a main component that affects the radio signal.

It is assumed in FIG. 1 that, by way of example, the spectrum A1 of the thermal noise has a value of −108 dBm, and a component N1 of the NF of the radio processing section in the radio communication device installed in a radio base station is +4 dB.

When a target SIR value T1 for a received signal from a higher-level device is +10 dB, an ideal received signal A2 is −98 dBm obtained by adding +10 dB to −108 dBm. However, since the NF component N1 of +4 dB of the radio processing section is not negligible, only a difference (=+6 dB) between the target SIR value T1 and the NF component N1 is actually obtained as gain G1.

When an interference component in a transmission path has a small value as a component that affects a radio signal, and only thermal noise on the transmission path is a main component that affects the radio signal as described above, the effect of a NF of the radio processing section is not negligible in detecting a SIR, resulting in deterioration of SIR gain.

Next, FIG. 2 illustrates another example for explaining the effect which internal noise (thermal noise) generated by the radio processing section has on SIR detection. In FIG. 2, the spectrum A1 of the thermal noise on the transmission path as well as an interference component 11 in transmission paths from a plurality of terminals exist as components that affect a radio signal.

It is assumed in FIG. 2 that, by way of example, the spectrum A1 of the thermal noise has a value of −108 dBm, and the spectrum II of the interference component from a plurality of terminals has a value of −85 dBm. And like FIG. 1, the component N1 of the NF of the radio processing section in the radio communication device installed in the radio base station is assumed to be +4 dB.

The spectrum sum of the thermal noise (spectrum A1) and the NF (component N1) is −108 dBm+4 dB=−104 dbm. Further, the spectrum sum of this spectrum sum of the thermal noise and the NF and the spectrum II of the interference component from a plurality of terminals is almost −85 dBm as indicated by a spectrum A3. The reason is that because −85 dBm=3.16228×10⁻⁹ mW and −104 dBm=1.58489×10⁻¹¹ mW, the calculation result of 3.16228×10⁻⁹ mW+1.58489×10⁻¹¹ mW is almost 3.16228×10⁻⁹ mW, which can be approximated at −85 dBm.

Then, when the target SIR value T1 for a received signal from a higher-level device is +10 dBm, a received signal A4 is −75 dBm obtained by adding +10 dB to −85 dBm. In this case, since the NF component N1 of +4 dB of the radio processing section is negligible, a value almost the same as the target SIR value T1 (=+10 dB) is obtained as gain G2.

That is, the effect of a NF of the radio processing section included in a SIR is negligible when the interference component from a plurality of terminals has a large value, whereas a correction has to be made of removing the effect of a NF of the radio processing section included in a SIR when the interference component has a small value.

FIG. 3 shows the structure of a radio base station device 10 serving as a radio communication device according to this embodiment. This radio base station device 10 carries out radio signal communications of the CDMA (Code Division Multiple Access) system, and includes an antenna 1 serving as a gate for transmitting and receiving a radio signal, a transmitting and receiving device 2 which performs analog signal processing in a RF (Radio Frequency) area of the radio signal in the subsequent stage to the antenna, and a baseband processing section 3 which performs signal processing (digital signal processing compliant with the CDMA system) in a baseband area of the radio signal in the subsequent stage to the transmitting and receiving device 2.

The transmitting and receiving device 2 which performs analog signal processing in the RF area includes a radio processing section 4 including a variable gain amplifier, an attenuator and the like, and a baseband processing-radio processing interface section 5 including an AD (Analog to Digital) converter, a DA (Digital to Analog) converter and the like and functioning as an interface for exchanging a radio signal in the RE area between the baseband processing section 3 and the radio processing section 4.

The radio processing section 4, which is composed of various kinds of electric elements including a transistor, generates internal noise. The radio processing section 4 includes a NF detection section 11 which detects a NF (Noise Figure) serving as an indicator of that internal noise. The NF detection section 11 is connected to an interface 12 capable of transmitting information about the NF.

The baseband processing-radio processing interface section 5 partially includes a RSSI measurement section 13 which measures a RSSI (Received Signal Strength Indicator) indicating reception strength of a radio signal. The RSSI measurement section 13 is connected to an interface 14 capable of transmitting information about the RSSI.

The baseband processing section 3 which performs signal processing in the baseband area includes a digital modulation section 6, a digital demodulation section 7, a channel coding/decoding section 8, and a cable processing section 9. When transmitting a radio signal, the cable processing section 9 performs cable processing such as formatting the to-be-transmitted signal, and the channel coding/decoding section 8 encodes the to-be-transmitted signal. Then, the digital modulation section 6 modulates the encoded to-be-transmitted signal and sends it to the transmitting and receiving device 2. When receiving a radio signal, the digital demodulation section 7 demodulates the received signal, and the channel coding/decoding section 8 decodes the received signal. Then, the cable processing section 9 performs cable processing such as interpreting the format of the received signal.

In this embodiment, the digital demodulation section 7 includes a SIR detection device 71 which detects the SIR of a radio signal. Upon initial start-up of the radio base station device 10 having the radio processing section 4 installed therein, the SIR detection device 71 operates to obtain information about the NF in the radio processing section 4 from the NF detection section 11 via the interface 12, as part of a startup sequence of the radio base station device 10. Then, the SIR detection device 7 determines a value of power N added to the radio signal by the internal noise of the radio processing section 4 based on the information about the NF, and stores the value of the power N in a storage section (which includes a memory and a register) 71a provided therein.

The SIR detection device 71 also operates, when the radio base station device 10 performs reception processing of a radio signal and the RSSI measurement section 13 measures the RSSI of the received signal, to obtain information about the measured RSSI from the RSSI measurement section 13 via the interface 14. Then, the SIR detection device 71 detects a SIR using the power of the radio signal and the information about the RSSI. After detecting the SIR of the radio signal, the SIR detection device 7 corrects the detected SIR based on the information about the NF and the information about the RSSI.

In the course of the SIR detection in the SIR detection device 71, power I of an interference component included in the radio signal is calculated based on the information about the RSSI. However, since the RSSI is measured as I (power of the interference component)+N (power added to the radio signal by the internal noise of the radio processing section 4), the SIR calculated in the SIR detection device 71 includes the effect of the NF of the radio processing section 4. Such SIR including the effect of the NF of the radio processing section 4 is defined as a SINR (Signal to Interference and Noise Ratio) in this specification. A specified point of detecting the SIR is the input end of the antenna 1, while a specified point of detecting the SINR is the input end of the digital demodulation section 7.

Considering the above explanation with reference to FIGS. 1 and 2, when the power I of the interference component is high, the effect of the NF of the radio processing section 4 is negligible and thus an equation RSSI=I holds, resulting in SIR=SINR. When the power I of the interference component is low, on the other hand, the effect of the NF of the radio processing section 4 is not negligible and thus the equation RSSI=I does not hold, resulting in the SIR and SINR having different values.

This is expressed mathematically. First, a SIR is expressed by the following equation (1):

[Numeral 1]

SIR=S/I (1)

where S represents power of a signal component, and I represents power of an interference component. A SINR is expressed by the following equation (2):

[Numeral 2]

SINR=S/(I+N) (2)

where N represents power added to a radio signal by internal noise of the radio processing section 4.

From the equations (1) and (2), the relation between the SIR and SINR is expressed by the following equation (3):

[Numeral 3]

SIR=SINR×(I+N)/I (3)

Transforming the above equation (3) to logarithm, the following equation (4) is obtained:

[Numeral 4]

SIR=SINR+10×log(I+N)−10×log I (4)

As can be seen from the equation (4), a transformation equation from the SINR to the SIR is a function of the power I of the interference component and the power N of the internal noise component of the radio processing section 4. The amount of that transformation is a value with 10×log(I+N)−10×logI. Namely, upon detecting a SINR, the amount of correction with 10×log(I+N)−10×logI based on the power N of the internal noise and the power I of the interference component is subtracted from the detected SINR value, thereby making a correction of removing the power N of the internal noise included in the SINR.

As such, in the present invention, the SIR detection device 71 in the digital demodulation section 7 corrects the SINR to the SIR using the value of the power I of the interference component and the value of the power N of the internal noise component of the radio processing section 4 based on the equation (4).

More specifically, upon initial start-up of the radio base station device 10, the SIR detection device 71 obtains in advance information about the NF from the radio processing section 4, determines a value of the power N of the internal noise, and stores the value of the power N in the storage section 71a. In addition, the SIR detection device 71 divides a range of possible values for the power I of the interference component into a plurality of ranges, and calculates in advance the amounts of correction with the above 10×log(I+N)−10×logI range by range based on a representative value of each range and the value of the power N of the internal noise. Then, the SIR detection device 71 stores the calculated amounts of correction in a table provided in the storage section 71a.

FIG. 4 shows Table 15 such as mentioned above. In Table 15, the range of possible values for the power I of the interference component is divided at 0.1-dBm intervals, from less than −108.0 dBm (index 0), −108.0 dBm or more but less than −107.9 dBm (index 1), −107.9 dBm or more but less than −107.8 dBm (index 2), . . . , −85.1 dBm or more but less than −85.0 dBm (index 229), to −85.0 dBm or more (index 230). The amounts of correction with the above 10×log(I+N)−10×logI are calculated range by range as a0 to a230 [dB], and the calculated amounts of correction a0 to a230 are stored in Table 15.

The amounts of correction a0 to a230 are calculated range by range based on a representative value of each range and the value of the power N of the internal noise. As a representative value of the range of −108.0 dBm or more but less than −107.9 dBm (index 1), for example, a central value of −107.95 dBm may be employed, or a minimum value of −108.0 dBm or a maximum value of −107.9 dBm within the range may be employed. As for the power N of the internal noise, the spectrum component of the NF (+4 dB) shown in FIGS. 1 and 2 can be used.

In correcting the SINR to the SIR, the SIR detection device 71 refers to the power I of the interference component calculated based on the RSSI, to read one of the amounts of correction a0 to a230 that corresponds to the value of the power I of the interference component from Table 15. Then, the SIR detection device 71 corrects the SINR to the SIR by subtracting the read amount of correction based on the equation (4).

For example, when a value of the RSSI obtained from the RSSI measurement section 13 (which corresponds to the power I of the interference component) is −91.0 dBm, the SIR detection device 71 refers to an index 171 to which −91.0 dBm belongs in Table 15. Table 15 shows that the amount of correction is a171 [dB], so the SIR detection device 71 subtracts the amount of correction a171 [dB] from the SINR that has been detected, to obtain the SIR.

According to the SIR detection device and the radio communication device of this embodiment, the calculation is performed on the detected SINR value with the amounts of correction a0 to a230 based on the power N of the internal noise added to the radio signal by the radio processing section 4 and the power I of the interference component, thereby making a correction of removing the power N of the internal noise included in the SINR. As a result, a SIR not affected by the internal noise of the radio processing section 4 is obtained, thereby realizing a SIR detection device and a radio communication device capable of detecting a SIR value with precision.

Moreover, the SIR detection device of this embodiment divides a range of possible values for the power I of the interference component into a plurality of ranges, calculates in advance the amounts of correction a0 to a230 range by range based on a representative value of each range and the value of the power N of the internal noise, stores the calculated amounts of correction a0 to a230 in Table 15, and reads one of the amounts of correction a0 to a230 that corresponds to the value of the power I of the interference component from Table 15 when making a correction. Therefore, it is only required to read one of the amounts of correction a0 to a230 from Table 15 without having to calculate the amount of correction with each correction, thereby making the correction quickly.

The present invention is particularly effective when the radio processing section 4 and the baseband processing section 3 are manufactured by different companies, and the baseband processing section 3 is not supplied with the NF of the radio processing section 4 as initial information.

The performance of the radio processing section 4 depends on the manufacturer, product lineup and the like, and a NF value of the radio processing section 4 varies accordingly. Upon initial start-up of the radio base station device 10, a SIR needs to be detected for equipment adjustments in the baseband processing section 3. According to the SIR detection device and the radio communication device of the present invention, the SIR detection device 71 detects a SIR value with precision based on the information about the NF of the radio processing section 4 installed in the radio base station device 10, so that the devices of the radio processing section 4 and the baseband processing section 3 can be combined freely to realize the radio base station device 10 without being restricted by the manufacturer, product lineup and the like. The present invention is effective in this respect. This invention is also effective when replacing or changing the radio processing section 4 because the SINR can be corrected to the SIR upon the replacement or change.

Whether or not to make the above correction from the SINR to the SIR is selectable in the SIR detection device 71. This is because while the effect of the NF of the radio processing section included in the SIR needs to be removed when the interference component has a small value as depicted in FIG. 1, the effect of the NF of the radio processing section included in the SIR is negligible when the interference component has a large value as depicted in FIG. 2.

By making the correction selectable, in a worse case scenario where the SIR is affected by the internal noise of the radio processing section 4 after selecting not to make the correction, the performances of the other communication processing sections including the baseband processing section 3 can be assessed, thereby increasing reliability of performance assessment.

### Second Preferred Embodiment

This embodiment is a modified example of the SIR detection device and the radio communication device according to the first preferred embodiment, and makes a first correction similar to the first preferred embodiment of transforming a detected SINR to a SIR, and further makes a second correction of reducing an error involved in an estimate of the SIR by performing calculation on the SIR with the amount of correction based on the number of pilot bits in the CDMA system.

A SIR detection device and a radio communication device according to this embodiment are similar in structure to those according to the first preferred embodiment, only with a difference in correction processing by the SIR detection device 71 shown in FIG. 2.

FIG. 5 shows vectors obtained by calculating back diffusion of a pilot bit signal in the CDMA system. By way of example, the pilot bit is 3 bits in FIG. 5.

FIG. 6 shows the structure of an upward control signal (DPCCH) 23 of the W-CDMA (Wideband-CDMA), and FIG. 7 shows a table called the Slot Format indicating various indexes that determine a signal structure and the numbers of those indexes. The sign “TFCI 23b” in the control signal 23 shown in FIG. 6 indicates a “Transport Format Combination Indicator”, the sign “FBI 23c” indicates “Feedback Information”, and the sign “TPC 23d” indicates “Transfer Power Control”, respectively.

As depicted in FIG. 7, there are twelve indexes from 0 to SB of the Slot Format. Each Slot Format has a different number of pilot bits, with possible values for the number of pilot bits being in the 3 to 8 range. As the number of pilot bits increases, an error in a demodulated signal by a pilot estimate becomes smaller.

Vectors 16, 17 and 18 shown in FIG. 5 are back-diffusion vectors R_SIG(i)(i=0, 1, 2) of pilot bit signals SIG(i)(i=0, 1, 2), respectively, and a vector 19 is an ideal point of the demodulated signal. Vectors 20, 21 and 22 are interference components of the respective pilot bit signals, and can be expressed as INTER(i)(i=0, 1, 2). Demodulated signal power (power of the vector 19) SIG_POW is an average value of the back-diffusion results of the respective pilot bit signals, and is obtained as expressed by the following equation (5):

[Numeral 5]

$$\begin{matrix}SIG\_POW = {\vert \frac{{\sum }_{i = 0}^{N\_PILOT - 1} R\_SIG ( i )}{N\_PILOT} \vert}^{2} \\ = {\vert \frac{{\sum }_{i = 0}^{N\_PILOT - 1} ( SIG ( i ) + INTER ( i ) )}{N\_PILOT} \vert}^{2} \\ = \frac{\begin{matrix}{\vert {\sum }_{i = 0}^{N\_PILOT - 1} SIG ( i ) \vert}^{2} + 2 \times {\sum }_{i = 0}^{N\_PILOT - 1} SIG ( i ) \times \\ {\sum }_{i = 0}^{N\_PILOT - 1} INTER ( i ) + {\vert {\sum }_{i = 0}^{N\_PILOT - 1} INTER ( i ) \vert}^{2}\end{matrix}}{{N\_PILOT}^{2}}\end{matrix} \qquad ( 5 )$$

where N_PILOT represents the number of pilot bits. The sign INTER(i) represents the Gaussian distribution, with its distribution being multiplied by √ (N_PILOT). Meanwhile, the signal component SIG(i), which is assumed to be a constant value, is regarded as an average value and is expressed as SIG(i)=SIG_AVE. As a result, the following equation (6) is obtained:

[Numeral 6]

$$SIG\_POW = {SIG\_AVE}^{2} + \frac{2 \times N\_PILOT \times SIG\_AVE \times INTER\_AVE}{\sqrt{N\_PILOT}} + \frac{{INTER\_AVE}^{2}}{N\_PILOT} \qquad ( 6 )$$

The sign INTER_AVE represents an average value of the interference component INTER(i). The average value INTER_AVE is an average value of N_PILOT seen in terms of long period of time. For the value of INTER_AVE to be zero, the following equation (7) is formulated:

[Numeral 7]

$$\frac{2 \times N\_PILOT \times SIG\_AVE \times INTER\_AVE}{\sqrt{N\_PILOT}} = 0 \qquad ( 7 )$$

Therefore, the equation (6) is expressed by the following equation (8):

[Numeral 8]

$$SIG\_POW = {SIG\_AVE}^{2} + \frac{{INTER\_AVE}^{2}}{N\_PILOT} \qquad ( 8 )$$

which indicates that the term of (INTER_AVE²/N_PILOT) is additionally added to the signal component.

Next, a power value INT_POW of the interference component will be calculated. The power value INT_POW can be obtained as dispersion of the back-diffusion results R_SIG(i)(i=0, 1, 2), and is thus obtained as expressed by the following equation (9):

[Numeral 9]

$$INT\_POW = \frac{N\_PILOT \times {\sum }_{i = 0}^{N\_PILOT} {\vert SIG ( i ) \vert}^{2} - {\vert {\sum }_{i = 0}^{N\_PILOT} SIG ( i ) \vert}^{2}}{{N\_PILOT}^{2}} \qquad ( 9 )$$

From the equations (5) and (8), the following equation (10) is derived:

[Numeral 10]

$${\vert {\sum }_{i = 0}^{N\_PILOT} SIG ( i ) \vert}^{2} = {N\_PILOT}^{2} \times \{ {SIG\_AVE}^{2} + \frac{{INTER\_AVE}^{2}}{N\_PILOT} \} \qquad ( 10 )$$

The average value INTER_AVE is an average value of N_PILOT seen in terms of long period of time. For the value of INTER_AVE to be zero, the power value INT_POW of the interference component is expressed by the following equation (11):

[Numeral 11]

$$\begin{matrix}{\sum }_{i = 0}^{N\_PILOT - 1} {\vert SIG ( i ) \vert}^{2} = N\_PILOT ( {SIG\_AVE}^{2} + 2 \times SIG\_AVE \times \\ {INTER\_AVE}^{2} ) \\ = N\_PILOT ( {SIG\_AVE}^{2} + {INTER\_AVE}^{2} )\end{matrix} \qquad ( 11 )$$

Substituting the equation (9) into the equations (10) and (11) yields the following equation (12), which is a value obtained by multiplying a to-be-obtained value by ((N_PILOT-1)N_PILOT):

[Numeral 12]

$$\begin{matrix}INT\_POW = \frac{\begin{matrix}{N\_PILOT}^{2} ( {SIG\_AVE}^{2} + {INTER\_AVE}^{2} ) - \\ {N\_PILOT}^{2} \times \{ {SIG\_AVE}^{2} + \frac{{INTER\_AVE}^{2}}{N\_PILOT} \}\end{matrix}}{{N\_PILOT}^{2}} \\ = \frac{N\_PILOT - 1}{N\_PILOT} \times {INTER\_AVE}^{2}\end{matrix} \qquad ( 12 )$$

Next, the SIR will be calculated. Using the equations (9) and (12), the following equation (13) is derived:

[Numeral 13]

$$\begin{matrix}SIR = \frac{{SIG\_AVE}^{2}}{{INT\_AVE}^{2}} \\ = \frac{SIG\_POW - \frac{{INTER\_AVE}^{2}}{N\_PILOT}}{{INT\_AVE}^{2}} \\ = \frac{SIG\_POW}{{INT\_AVE}^{2}} - \frac{1}{N\_PILOT} \\ = \frac{SIG\_POW}{\frac{N\_PILOT}{N\_PILOT - 1} \times INT\_POW} - \frac{1}{N\_PILOT} \\ = \frac{N\_PILOT - 1}{N\_PILOT} \times \frac{SIG\_POW}{INT\_POW} - \frac{1}{N\_PILOT}\end{matrix} \qquad ( 13 )$$

As demonstrated above, an estimated SIR value is expressed with a ratio of the demodulated signal power (vector 19) SIG_POW to the power value INT_POW of the interference component, and the number of pilot bits N_PILOT as parameters. The above equation (13) is an equation for calculation by the slot. The following equation (14) is an equation for calculation by two slots:

[Numeral 14]

$$SIR = \frac{N\_PILOT - 1}{N\_PILOT} \times \frac{SIG\_POW}{INT\_POW} - \frac{1}{2 \times N\_PILOT} \qquad ( 14 )$$

As can be seen from the equations (13) and (14), the amount of correction to an error in a SIR estimate is a coefficient of the number of pilot bits N_PILOT.

The SIR detection device 71 according to this embodiment makes the first correction similar to the first preferred embodiment of transforming a detected SINR to a SIR based on the equation (4), and then further makes the second correction of reducing an error involved in an estimate of the SIR by performing calculation on the SIR with the amount of correction based on the number of pilot bits in the CDMA system ((N_PILOT-1)/N_PILOT) including N_PILOT as a constituent element and each component of 1/N_PILOT) based on the equations (13) and (14).

Namely, the SIR detection device 71 according to this embodiment further makes second correction of multiplying the SIR value, which has been subjected to the first correction of removing the effect of the NF of the radio processing section 4 from the SINR based on the information about the number of pilot bits N_PILOT determined by the demodulated signal in the digital demodulation section 7, by ((N_PILOT-1)/N_PILOT) and of subtracting 1/N_PILOT from the SIR (when calculated by the slot. It is 1/(2×N_PILOT) when calculated by two slots).

In this second correction, values of ((N_PILOT-1)/N_PILOT) and 1/N_PILOT (or 1/(2×N_PILOT)) vary depending on the number of pilot bits. Thus in this embodiment, a range of possible values for the SIR which has been subjected to the first correction is divided into a plurality of ranges, and the amount of correction is calculated in advance for each number of pilot bits based on the number of pilot bits N_PILOT. Then, calculation is performed on the representative values of the ranges with those calculated amounts of correction, and the calculated results are stored in a table provided in the storage section 71a.

FIG. 8 shows Table 24 such as mentioned above. In Table 24, the range of possible values for the SIR which has been subjected to the first correction is divided at 0.1-dB intervals, from −11.1 dB (index 0), −11.0 dB (index 1), −10.9 dB (index 2), . . . , to +20.0 dB (index 311). Two or more decimal places of the SIR value which has been subjected to the first correction are rounded up or down, for the SIR value to belong to one of the index ranges. As a representative value of each range, the value of each index may be employed (e.g. −11.0 dB for the index 1). In addition, values less than −11.1 dB may be regarded as −11.1 dB, and values larger than +20.0 dB may be regarded as +20.0 dB.

Then, the amount of correction with the above ((N_PILOT-1)/N_PILOT) and 1/N_PILOT (or 1/(2×N_PILOT)) is calculated for each number of pilot bits N_PILOT (the number of pilot bits is assumed to be one of 3 to 8 in this case), and calculation is performed on the representative values of the ranges with those calculated values based on the equations (13) and (14), and the calculated results are stored in Table 24 as a03 to a08 [dB], a13 to a18 [dB], . . . , and a3113 to a3118 [dB].

For example, when a SIR value which has been subjected to the first correction is +4.5 dB and the number of pilot bits is 4, the SIR detection device 71 reads information about a calculated result a1564 [dB], which is obtained by performing calculation on the representative value of +4.5 dB of an index 156 with the amount of correction corresponding to the number 4 of pilot bits based on information about the index 156 and information about the number 4 of pilot bits, as a calculated result of the second correction. This read value is a detected SIR.

According to the SIR detection device and the radio communication device of this embodiment, the first correction is made to transform the detected SINR to the SIR, and further the second correction is made of reducing an error involved in an estimate of the SIR by performing calculation on the SIR with the amount of the second correction based on the number of pilot bits in the CDMA system. This attains a SIR detection device capable of detecting a SIR value with higher precision in the CDMA system.

Also according to the SIR detection device and the radio communication device of this embodiment, a range of possible values for the SIR which has been subjected to the first correction is divided into a plurality of ranges, and the amount of correction (((N_PILOT-1)/N_PILOT) and 1/N_PILOT (or 1/(2×N_PILOT))) is calculated in advance for each number of pilot bits based on the number of pilot bits. Then, calculation is performed on the representative values of the ranges with the calculated amounts of correction, and the calculated results are stored in Table 24 and read from Table 24 when making the second correction. Therefore, it is only required to read a calculated result obtained in advance from the table without having to calculate the amount of correction with each second correction, thereby making the second correction quickly.

### Third Preferred Embodiment

This embodiment is also a modified example of the SIR detection device and the radio communication device according to the first preferred embodiment, with the radio processing section 4 according to the first preferred embodiment being one selected from a plurality of radio processing sections, and calculates the amount of correction based on power N corresponding to the selected radio processing section.

FIG. 9 shows the structure of the radio base station device 10 serving as a radio communication device according to this embodiment. This radio base station device 10 employs, instead of the radio processing section 4 in the radio base station device 10 according to the first preferred embodiment, one radio processing section (e.g. 41) selected from a plurality of various radio processing sections 41 to 4n (n: natural number) depending on the manufacturer, product lineup and the like. There are also a plurality of NF values corresponding to the plurality of radio processing sections 41 to 4n, respectively.

In the radio base station device 10 according to this embodiment, the digital demodulation section 7 is replaced by a digital demodulation section 7a including a SIR detection device 72. The SIR detection device 72 detects the SIR of a radio signal like the SIR detection device 71 does, and includes a storage section 72a including a memory and a register.

Unprovided in this embodiment is an interface by which the radio processing sections 41 to 4n notify their NFs, like the interface 12 of the first preferred embodiment. Thus during a startup sequence of the radio base station device 10, the SIR detection device 72 does not automatically obtain information about the NFs of the radio processing sections 41 to 4n.

Although a notifying interface is not provided, the SIR detection device 72 is provided with information about the NFs of the radio processing sections 41 to 4n. In this embodiment, all information about the NFs of the radio processing sections 41 to 4n is supplied to the SIR detection device 72 by a staff such as a maintenance person of the radio base station device 10, to be stored in a first Table 25 of the storage section 72a in the SIR detection device 72. In FIG. 9, NF component values corresponding to the n radio processing sections 41 to 4n, respectively, are stored as b1 to bn [dB] in the first Table 25. The storage section 72a is provided with not only the first Table 25 but also a second Table 26.

The other elements are similar to those of the radio base station device 10 according to the first preferred embodiment, and will thus not be explained below.

In this embodiment, the SIR detection device 72 determines a value of each power N added to a radio signal by internal noise of the radio processing sections 41 to 4n based on the information about the NFs stored in the first Table 25. Then, the SIR detection device 72 corrects the SINR to the SIR using the value of the power I of the interference component and the value of the power N corresponding to a radio processing section (e.g. 41) selected from the radio processing sections 41 to 4n based on the equation (4).

More specifically, upon initial start-up of the radio base station device 10, the SIR detection device 72 calculates in advance the amount of correction with 10×log(I+N)−10×logI in the equation (4) for each of the radio processing sections 41 to 4n, and for each of the ranges of possible values for the power I of the interference component using the NF values of the radio processing sections 41 to 4n stored in the first Table 25. Then, the SIR detection device 72 stores the calculated amounts of correction in the second Table 26.

FIG. 10 shows the second Table 26 such as mentioned above. The second Table 26 includes storage areas 26a, 26b, . . . , and 26c for the amounts of correction of the first radio processing section 41 to the n-th radio processing section 4n, respectively. And as depicted by the storage area 26b magnified in FIG. 10, in each of the storage areas, the range of possible values for the power I of the interference component is divided at 0.1-dBm intervals, from less than −108.0 dBm (index 0), −108.0 dBm or more but less than −107.9 dBm (index 1), −107.9 dBm or more but less than −107.8 dBm (index 2), −85.1 dBm or more but less than −85.0 dBm (index 229), to −85.0 dBm or more (index 230). The amounts of correction with the above 10×log(I+N)−10×logI are calculated range by range as y0 to y230 [dB], and the calculated amounts of correction y0 to y230 are stored in the storage areas 26a, 26b, . . . , and 26, respectively, in the second Table 26.

The amounts of correction y0 to y230 are calculated range by range based on a representative value of each range and a value of each power N of the internal noise of the first radio processing section 41 to the n-th radio processing section 4n. As a representative value of the range of −108.0 dBm or more but less than −107.9 dBm (index 1), for example, a central value of −107.95 dBm may be employed, or a minimum value of −108.0 dBm or a maximum value of −107.9 dBm within the range may be employed. As for each power N of the internal noise of the first radio processing section 41 to the n-th radio processing section 4n, the spectrum component of the NF (+4 dB) shown in FIGS. 1 and 2 can be used.

In correcting the SINR to the SIR, the SIR detection device 72 refers to the power I of the interference component calculated based on the RSSI, to read one of the amounts of correction y0 to y230 based on the power N corresponding to one of the first radio processing section 41 to the n-th radio processing section 4n that has been selected to be installed in the radio base station device 10 and the power I of the interference component from the second Table 26. Then, the SIR detection device 72 corrects the SINR to the SIR by subtracting the read amount of correction from the SINR based on the equation (4).

For example, when a second radio processing section 42, which is a product B manufactured by a company A, is employed among the first radio processing section 41 to the n-th radio processing section 4n to be installed in the radio base station device 10, a maintenance person of the radio base station device 10 informs the SIR detection device 72 upon initial start-up of the radio base station device 10 that the second radio processing section 42 is employed in the radio base station device 10.

When a value of the RSSI obtained from the RSSI measurement section 13 (which corresponds to the power I of the interference component) is −91.0 dBm, the SIR detection device 71 refers to the storage area 26b corresponding to the second radio processing section 42, and refers to an index 171 to which −91.0 dBm belongs in the storage area 26b. The storage area 26b shows that the amount of correction is y171 [dB], so the SIR detection device 72 subtracts the amount of correction y171 [dB] from the SINR that has been detected, to obtain the SIR.

After the correction of transforming the SINR to the SIR, the second correction of reducing an error involved in an estimate of the SIR may be made by performing calculation with the amount of correction based on the number of pilot bits, as described in the second preferred embodiment.

According to the SIR detection device and the radio communication device of this embodiment, when making the correction of transforming the detected SINR to the SIR, calculation is performed on the detected SINR value with the amount of correction based on the power N corresponding to a radio processing section selected from the plurality of radio processing sections 41 to 4n and the power I of the interference component. As a result, a SIR not affected by the internal noise is obtained when any of the plurality of various radio processing sections 41 to 4n is selected, thereby realizing a SIR detection device capable of detecting a SIR value with precision.

Moreover, the SIR detection device and the radio communication device of this embodiment divide a range of possible values for the power I of the interference component into a plurality of ranges, calculate in advance the amount of correction for each of the ranges and for each of the plurality of radio processing sections 41 to 4n based on a representative value of each range and the value of each power N of the internal noise of the plurality of radio processing sections 41 to 4n, store the calculated amounts of correction in Table 26, and read one of the amounts of correction that corresponds to the value of the power I of the interference component and a radio processing section selected from the plurality of radio processing sections 41 to 4n from Table 26 when making a correction of transforming the SINR to the SIR. Therefore, it is only required to read one of the amounts of correction from Table 26 without having to calculate the amount of correction with each correction of transforming the SINR to the SIR, thereby making the correction quickly.

### Fourth Preferred Embodiment

This embodiment is a modified example of the SIR detection device and the radio communication device according to the first and second preferred embodiments, and makes a first correction of removing the power N of the internal noise included in the SIR using a sheet of table combining Table 15 of the first preferred embodiment and Table 24 of the second preferred embodiment, and also makes a second correction of reducing an error involved in an estimate of the SIR based on the number of pilot bits in the CDMA system.

A SIR detection device and a radio communication device according to this embodiment are similar in structure to those according to the first preferred embodiment, only with a difference in correction processing by the SIR detection device 71 shown in FIG. 2.

FIG. 11 shows Table 27 for collectively subjecting a detected SINR value to the first correction of removing the power N of the internal noise included in the SINR by subtracting the amount of correction with 10×log(I+N)−10×logI based on the power N of the internal noise and the power I of the interference component in the equation (4), and the second correction of reducing an error involved in an estimate of the SIR by performing calculation with the amount of correction ((components of (N_PILOT-1)/N_PILOT and 1/N_PILOT)) based on the number of pilot bits in the CDMA system in the equations (13) and (14).

In Table 27, the range of possible values for the power I of the interference component is divided at 0.1-dBm intervals as first ranges, from less than −108.0 dBm (index 0), −108.0 dBm or more but less than −107.9 dBm (index 1), −107.9 dBm or more but less than −107.8 dBm (index 2), . . . , −85.1 dBm or more but less than −85.0 dBm (index 229), to −85.0 dBm or more (index 230). The amounts of correction with the above 10×log(I+N)−10×logI are calculated in advance first range by first range depending on the value of the power N as a plurality of amounts of first correction.

Further in this embodiment, the range of possible values for the SINR to be detected is divided as second ranges. In Table 27, the possible values for the SINR to be detected is divided at 0.1-dB intervals, from −11.1 dB, −11.0 dB, −10.9 dB, to +20.0 dB. Two or more decimal places of the detected SINR value are rounded up or down, for the SIR value to belong to one of the index ranges. As a representative value of each range, the value of each index may be employed (e.g. −11.0 dB for the index 1). In addition, values less than −11.1 dB may be regarded as −11.1 dB, and values larger than +20.0 dB may be regarded as +20.0 dB.

Then, each representative value of each of the second ranges is calculated with each of the amounts of first correction thus calculated, to obtain a first calculated value. This first calculated value is each value of the SIR which has been subjected to the removal of the power N of the internal noise of the radio processing section 4 from the SINR.

Then, the amount of second correction with the above ((N_PILOT-1)/N_PILOT) and 1/N_PILOT (or 1/(2×N_PILOT)) is calculated for each number of pilot bits N_PILOT (the number of pilot bits is assumed to be one of 3 to 8 in this case), and calculation is performed on the first calculated values with those calculated values based on the equations (13) and (14), and the calculated results are stored in Table 27 as second calculated values a-0-0-3 to a-0-0-8 [dB], a-0-1-3 to a-0-1-8 [dB], . . . , a-0-311-3 to a-0-311-8 [dB], a-1-0-3 to a-1-0-8 [dB], . . . , a-1-311-3 to a-1-311-8 [dB], . . . , a-230-0-3 to a-230-0-8 [dB], . . . , a-230-311-3 to a-230-311-8 [dB].

When a value of the RSSI obtained from the RSSI measurement section 13 (which corresponds to the power I of the interference component) is −91.0 dBm, a detected SINR value is +4.5 dB, and the number of pilot bits is 5, for example, the SIR detection device 71 reads information about a second calculated value a-171-156-5 [dB] corresponding to the value −91.0 dBm of the power I of the interference component, the detected SINR value +4.5 dB and the number 5 of pilot bits based on a column of +4.5 dB of the SINR value and information about the number 5 of pilot bits in the index 171 to which −91.0 dBm belongs in Table 27, as a calculated result of the first and second corrections.

According to the SIR detection device and the radio communication device of this embodiment, when making the first and second corrections, a second calculated value is read from Table 27 that corresponds to the value of the power I of the interference component, the detected SIR value and the number of pilot bits. Therefore, it is only required to read a second calculated value from Table 27 without having to calculate the amounts of first and second corrections when making the first and second corrections, thereby making the first and second corrections quickly. In addition, since calculation is performed on the first calculated values with the calculated amounts of second correction (((N_PILOT-1) N_PILOT) and 1/N_PILOT (or 1/(2×N_PILOT))), and the calculated results are stored as second calculated values in Table 27, to be read from Table 27 when making the first and second corrections, the first and second corrections do not need to be made in two stages, but can be made collectively and quickly.

While the invention has been shown and described in detail, the foregoing description is in all aspects illustrative and not restrictive. It is therefore understood that numerous modifications and variations can be devised without departing from the scope of the invention.

1: A SIR detection device, comprising:
a detection section for detecting a ratio of a signal component to an interference component (SIR: Signal to Interference Ratio) indicating the power ratio of a signal component to an interference component of a radio signal;
a first determination section for determining a value of power N added to said radio signal by internal noise of a radio processing section based on a NF (Noise Figure) of said radio processing section that performs analog signal processing in a RF (Radio Frequency) area of said radio signal;
a second determination section for determining a value of power I of an interference component included in said radio signal based on a RSSI (Received Signal Strength Indicator) indicating reception strength of said radio signal; and
a correction section for performing calculation on the detected value of said SIR with the amount of first correction based on said power N of said internal noise and said power I of said interference component, thereby making a first correction of removing said power N of said internal noise included in said SIR.

2: The SIR detection device according to claim 1, wherein
said first determination section obtains in advance information about said NF from said radio processing section to determine said value of said power N of said internal noise, and
said correction section divides a range of possible values for said power I of said interference component into a plurality of ranges, calculates in advance said amount of first correction for each of said ranges based on a representative value of each of said ranges and said value of said power N of said internal noise, stores said amounts of first correction calculated in a table, and reads one of said amounts of first correction that corresponds to said value of said power I of said interference component I from said table when making said first correction.

3: The SIR detection device according to claim 1, wherein
said radio signal is a signal of the CDMA (Code Division Multiple Access) system, and
said correction section makes a second correction of reducing an error involved in an estimate of said SIR by performing calculation on said SIR having been subjected to said first correction with the amount of second correction based on the number of pilot bits in the CDMA system.

4: The SIR detection device according to claim 3, wherein said correction section divides a range of possible values for said SIR which has been subjected to said first correction into a plurality of ranges, calculates in advance said amount of second correction for each number of said pilot bits based on said number of pilot bits, performs calculation on a representative value of each of said ranges with said amount of second correction, stores the calculated results in a table, and reads one of said calculated results that corresponds to a value of said SIR which has been subjected to said first correction and said number of pilot bits from said table when making said second correction.

5: The SIR detection device according to claim 3 wherein
said first determination section obtains in advance information about said NF from said radio processing section to determine said value of said power N of said internal noise, and
said correction section divides a range of possible values for said power I of said interference component into a plurality of first ranges, divides a range of possible values for said SIR detected into a plurality of second ranges, calculates in advance said amount of first correction for each of said first ranges based on a representative value of each of said first ranges and said value of said power N of said internal noise, performs calculation on a representative value of each of said second ranges with said amount of first correction calculated, to obtain the calculated result as a first calculated value, calculates in advance said amount of second correction for each number of said pilot bits based on said number of pilot bits, performs calculation on each of said first calculated values with each of said amounts of second correction calculated, stores the calculated results as second calculated values in a table, and reads one of said second calculated values that corresponds to said value of said power I of said interference component, said value of said SIR and said number of said pilot bits from said table when making said first and second corrections.

6: The SIR detection device according to claim 1, wherein
said radio processing section is one selected from a plurality of radio processing sections, and said NF includes a plurality of NFs in a corresponding manner to said plurality of radio processing sections,
said first determination section determines said value of said power N added to said radio signal by each of said internal noises of each of said plurality of radio processing sections based on said plurality of NFs, and
said correction section performs calculation on the detected value of said SIR detected with said amount of first correction based on said power N corresponding to said radio processing section selected from said plurality of radio processing sections and said power I of said interference component when making said first correction.

7: The SIR detection device according to claim 6, wherein
said first determination section obtains in advance information about said plurality of NFs to determine said value of said power N of each of said internal noises, and
said correction section divides a range of possible values for said power I of said interference component into a plurality of ranges, calculates in advance said amount of first correction for each of said ranges and each of said plurality of radio processing sections based on a representative value of each of said ranges and said value of said power N of each of said internal noises, stores said amounts of first correction calculated in a table, and reads one of said amounts of first correction that corresponds to said value of said power I of said interference component and said radio processing section selected from said plurality of radio processing sections from said table when making said first correction.

8: The SIR detection device according to claim 1, capable of selecting whether or not to make said first correction.

9: A radio communication device, comprising:
a radio processing section for performing analog signal processing in a (Radio Frequency) area of a radio signal;
a RSSI measurement section for measuring a RSSI (Received Signal Strength Indicator) indicating reception strength of said radio signal; and
a demodulator including a SIR detection device,
wherein said SIR detection device includes:
a detection section for detecting a ratio of a signal component to an interference component (SIR: Signal to Interference Ratio) indicating the power ratio of a signal component to an interference component of said radio signal;
a first determination section for determining a value of power N added to said radio signal by internal noise of said radio processing section based on a NF (Noise Figure) of said radio processing section;
a second determination section for determining a value of power I of an interference component included in said radio signal based on said RSSI; and
a correction section for performing calculation on the detected value of said SIR with the amount of first correction based on said power N of said internal noise and said power I of said interference component, thereby making a first correction of removing said power N of said internal noise included in said SIR.
